(19) United States
(12) Patent Application Publication
(10) Pub. No.: US 2026/0296098 A1
(43) Pub. Date: Oct. 1, 2026

(54) RIM, WHEEL AND METHOD OF FORMING SPOKE HOLES IN RIM

(71) Applicant: Bao Chi Fang (Xiamen) Technology Co., Ltd., Xiamen (CN)

(72) Inventors: Hongkai ZHU, Xiamen (CN); Wenfeng WU, Xiamen (CN); Xiaoyuan YU, Xiamen (CN); Zihua DENG, Xiamen (CN)

(21) Appl. No.: 19/194,804

(22) Filed: Apr. 30, 2025

(30) Foreign Application Priority Data
Mar. 31, 2025 (CN) 202510396666.1

(51) Int. Cl. B60B 1/04; B29C 70/24; B29C 70/38; B29C 70/54; B29K 101/10; B29L 31/32; B60B 21/06

(52) U.S. Cl. CPC B60B 1/043; B29C 70/24; B29C 70/386; B29C 70/541; B60B 21/06; B29K 2101/10; B29L 2031/32; B60B 2310/242; B60B 2360/341

(57) ABSTRACT

The disclosure relates to a rim, a wheel and a method of forming spoke holes in a rim. A basic shape of the spoke hole is formed by winding strip-shaped reinforcing units in a preforming stage before the rim is heat-cured, so continuity of reinforcing fibers at an edge of the spoke hole is maintained, thereby enhancing the ability of the edge of the spoke hole to bear an axial load.

### CROSS-REFERENCE TO RELATED APPLICATIONS

This application claims priority to Chinese Patent Application 202510396666.1, filed on Mar. 31, 2025, which is incorporated herein by reference.

### TECHNICAL FIELD

The disclosure relates to wheel manufacturing technology, and in particular to a structure of spoke holes of a rim in a bicycle wheel and a manufacturing method thereof.

### BACKGROUND

A typical bicycle wheel includes a rim, a hub and spokes connecting the rim and the hub. In the past, most bicycle rims were made of metal materials, such as aluminum, but in recent years, rims made of advanced reinforcing materials, mainly carbon fibers, have become more popular because of their excellent performance. The manufacturing process of such carbon fiber rims usually uses laminated carbon fiber sheets to form a wall structure of the rim. Carbon fiber sheets are used to preform a shape approximate to the rim and put into a thermoset mold for curing, and then, spoke holes are drilled at an end of the rim. When mounting the rim, the spoke is passed through the spoke hole, one end of the spoke is connected to a hole end of the spoke hole through a spoke connector, and the other end of the spoke is connected to the hub.

There is a problem in this spoke hole formed by drilling, that is, the continuous carbon fibers at the spoke hole are cut off during the spoke hole drilling process, and moreover, the spoke hole drilling process will also lead to formation of microcracks in the base material at the edge of the spoke hole, both of which lead to a reduced ability of the edge of the spoke hole to bear an axial load and lower the connection strength between the spoke hole and the spoke connector. In order to overcome this defect, some manufacturers add an additional material layer in the area of the spoke hole to increase its bearing strength, but this increases the weight of the rim.

### SUMMARY

In view of the above problems, the disclosure provides a rim and a method of forming spoke holes in a rim. A basic shape of the spoke hole is formed in a preforming stage before the rim is heat-cured, and continuity of the reinforcing fibers at an edge of the spoke hole is maintained.

The disclosure is realized by the following technical solutions:

The disclosure provides a rim, including a spoke connecting portion at a radial inner end. The spoke connecting portion is provided with spoke holes, a periphery of each of the spoke holes has strip-shaped reinforcing units, each of the reinforcing units includes at least one layer of reinforcing fibers, a plurality of the reinforcing units are stacked on top of each other around the spoke hole in a staggered manner, and at least part of the reinforcing units are combined to construct an outer contour of the spoke hole.

In one example, the reinforcing fibers are continuous or substantially continuous in a strip length direction of the reinforcing unit.

In one example, at least part of the reinforcing units are tangent to the spoke hole.

In one example, in a strip length direction of the reinforcing unit, the reinforcing unit bends and extends in an S-shaped path from the periphery of the first spoke hole to the periphery of the second spoke hole adjacent thereto in a manner of surrounding an axial direction of the spoke hole.

In one example, in a strip length direction of the reinforcing unit, the reinforcing unit bends in a manner of surrounding a circumferential direction of the rim.

In one example, the individual reinforcing unit bends in a U-shape, and a plurality of the reinforcing units form the U-shaped spoke connecting portion extending from the radial inner end to a radial outer end of the rim.

In one example, the reinforcing fibers of at least one of the reinforcing units are distributed on a same side of the spoke hole and bend away from the spoke hole toward a common direction.

In one example, the reinforcing fibers of at least one of the reinforcing units are distributed on two sides of the spoke hole and bend away from the spoke hole toward opposite directions.

In one example, inner side edges of the reinforcing units adjoining the spoke hole are stacked one by one and form the outer contour of the spoke hole.

In one example, the reinforcing fibers are carbon fibers.

In one example, at least one sheet-like reinforcing substrate is further laid on a side of the reinforcing unit facing outward in a radial direction of the rim.

Based on the rim described above, the disclosure further provides a wheel, including a rim, a hub and spokes connecting the rim and the hub. The rim is the rim described above, the spokes each extend through a spoke hole, and the spoke is connected to a spoke connecting portion of the rim through a spoke connector.

Moreover, the disclosure further provides a method of forming spoke holes in a rim, including:
arranging convex columns having a shape matched with that of the spoke holes;
winding strip-shaped reinforcing units around a periphery of each of the convex columns such that the reinforcing units gradually enclose the convex column and roughly construct an outer contour of the spoke hole; and
separating the convex columns from the reinforcing units.

In one example, the convex columns are arranged on a preform mold, the preform mold has an annular or arc-shaped structure, the plurality of convex columns are fixedly arranged at a radial inner end of the preform mold at intervals in a circumferential direction of the preform mold, and the convex columns roughly extend inward in a radial direction of the preform mold.

In one example, an end of the convex column facing inward in the radial direction of the preform mold has a sharp shape.

In one example, the preform mold is provided with grooves each around the periphery of the convex column, and the method further includes a step of laying at least one sheet-like reinforcing substrate in each of the grooves before winding the reinforcing units.

In one example, the method further includes a step of laying at least one layer of annular ribbon-shaped stiffener along a circumference at an inner end of the preform mold before winding the reinforcing units.

In one example, the reinforcing unit bends in a manner of surrounding a circumferential direction of the preform mold, and:
the reinforcing unit half-surrounds the preform mold in a manner of not passing through a radial outer end of the preform mold; or the reinforcing unit completely surrounds the preform mold in a manner of passing through the radial outer end of the preform mold, and the method further includes a step of removing part of each of the reinforcing units at the radial outer end of the preform mold after the winding of the reinforcing units is completed.

In one example, the reinforcing unit has a ribbon-shaped structure and is attached to a surface of the preform mold.

In one example, the reinforcing unit is wound in an S-shaped path from the periphery of the first convex column to the periphery of the second convex column adjacent thereto.

In one example, the reinforcing unit is curled into a rod shape before winding.

In one example, the method further includes a step of thermoset-molding the rim, where in a thermoset mold, a pin is inserted into each of the spoke holes formed by the enclosure of the reinforcing units.

The disclosure has the following beneficial effects: According to the disclosure, a basic shape of the spoke hole is formed in a preforming stage before the rim is heat-cured, and continuity of the reinforcing fibers at an edge of the spoke hole is not damaged, thereby solving the problems in the BACKGROUND, and enhancing the ability of the edge of the spoke hole to bear an axial load.

### BRIEF DESCRIPTION OF DRAWINGS

FIG. 1 is a schematic view of a wheel in an example;

FIG. 2 is a sectional view of the wheel in an example;

FIG. 3 is a schematic view of a preform mold in an example;

FIG. 4 is a schematic view of reinforcing units wound around a convex column on the preform mold in an example;

FIG. 5 is a planar developed view of the reinforcing units wound around the convex column in an example;

FIG. 6 is a developed view of the reinforcing units around a spoke hole after a rim is thermoset-molded in an example;

FIG. 7 is a schematic view of an alternative example of the example;

FIG. 8 is a schematic view of the reinforcing unit being pierced by squeezing by the convex column in an example;

FIG. 9 is a schematic view of another alternative example of the example;

FIG. 10 is a schematic view of a thermoset mold and a pin in an example;

FIG. 11 is a schematic view of a reinforcing substrate in an example; and

FIG. 12 is a schematic view of laying a stiffener on the preform mold in an example.

### DESCRIPTION OF EMBODIMENTS

To further illustrate the examples, the accompanying drawings are provided in the disclosure. These accompanying drawings are a part of the contents disclosed in the disclosure that are mainly used to illustrate the examples, and can be used in conjunction with the related descriptions in the specification to explain the operation principle of the examples. With reference to these contents, those of ordinary skill in the art should be able to understand other possible embodiments and advantages of the disclosure. Components in the drawings are not drawn to scale, and like component symbols are usually used to represent like components.

The disclosure will be further described in conjunction with the accompanying drawings and specific embodiments.

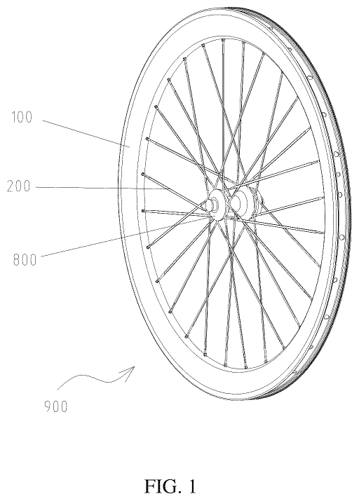

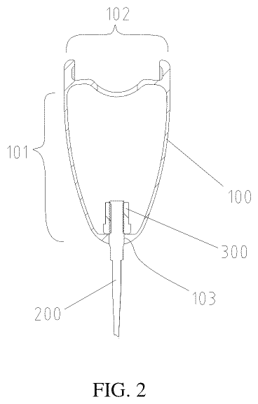

First, FIG. 1 and FIG. 2 respectively show a structure of a wheel 900 and a connecting structure of a rim 100 and a spoke 200. The wheel 900 includes the rim 100, a hub 800 and spokes 200 connecting the rim 100 and the hub. The rim 100 includes a spoke connecting portion 101 at a radial inner end and a top portion 102 at a radial outer end. The spoke connecting portion 101 is substantially U-shaped. Spoke holes 103 are provided at the bend of the spoke connecting portion 101, that is, at the innermost end of the spoke connecting portion 101. The spoke holes 103 substantially extend along a radial direction of the rim 100 (in some wheels, there is a small included angle between the spoke and the plane where the rim is located, and the spoke holes extend toward the center of circle along the radial direction or extend substantially along the radial direction with a slight eccentricity depending on how the spokes are woven between the rim and the hub). When the spoke 200 is to be connected to the rim 100, the spoke 200 is passed through the spoke hole 103, a spoke connector 300 is connected to an end of the spoke 200 that extends into the rim 100, and the other end of the spoke 200 is connected to the hub. The spoke 200 bears the tensile force, so that the spoke connector 300 is pressed against the edge of the spoke hole 103. Typically, the spoke connector 300 may be a threaded connector. It can be understood that the edge of the spoke hole 103 is always subjected to forces from the spoke 200 and the spoke connector 300, so the strength of the edge of the spoke hole 103 affects the service life of the rim 100 to some extent.

During the forming process of the rim 100, approximate shapes of the spoke connecting portion 101 and the top portion 102 are usually preformed respectively. Then, the approximate shapes of the spoke connecting portion 101 and the top portion 102 are spliced and put into a thermoset mold for heat-curing. Usually, an air bag may be placed in a chamber formed by the spoke connecting portion 101 and the top portion 102. Before heat-curing, the air bag is inflated, so that it can expand and press against an inner wall of the rim so as to obtain an ideal rim shape.

In the prior art, the material commonly used in shape forming of the rim 100 is a composite reinforcing material preimpregnated with a matrix material, for example, typically carbon fiber cloth preimpregnated with an epoxy resin. During the preforming process of the spoke connecting portion 101, the prior art always uses whole carbon fiber sheets laminated on an inner edge of an annular mold to form a U-shaped inward curve shape of the spoke connecting portion 101, the whole fiber sheets completely cover the positions of the spoke holes 103, and after the heat-curing of the rim 100 is completed, the spoke holes 103 are drilled in the spoke connecting portion 101.

This example first provides a method of forming spoke holes in a rim by winding. With this method, a basic shape of the spoke hole 103 is formed in a preforming stage before the rim 100 is heat-cured, and continuity of the carbon fibers at the edge of the spoke hole 103 is not damaged.

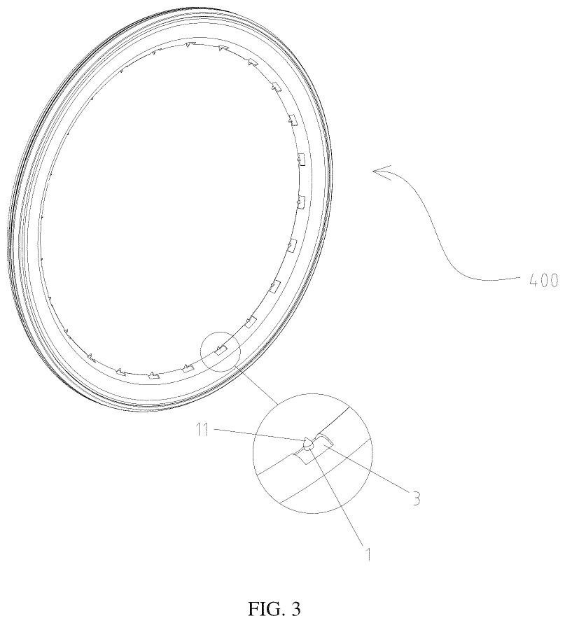

FIG. 3 shows a preform mold 400 used in this example. The preform mold 400 is configured to preform shapes at least around the spoke holes 103 on the spoke connecting portion 101. The preform mold 400 has an annular structure, so that the shape of a ring of spoke connecting portion 101 can be formed, or in other examples, the preform mold 400 may also have an arc-shaped structure, and the arcs are spliced to form the shape of a ring of spoke connecting portion 101. If the preform mold 400 has the arc-shaped structure, since the rim preform structure formed on the preform mold 400 needs to be further spliced, the forming accuracy will be slightly lower, but the arc-shaped preform mold 400 can be separated from the rim preform structure more easily. The preform mold 400 is provided with a plurality of convex columns 1 at a radial inner end, and the convex columns 1 have a shape matched with that of the spoke holes 103. The convex columns 1 are arranged at intervals in a circumferential direction of the preform mold 400. The number of the convex columns 1 depends on the number of the spoke holes in the rim, and the positions of the convex columns 1 also correspond to the positions of the spoke holes in the rim. It can be expected that the convex columns 1 also extend toward the center of circle along the radial direction or extend substantially along the radial direction with a slight eccentricity depending on how the spokes are woven between the rim and the hub, so as to finally form the spoke holes 103.

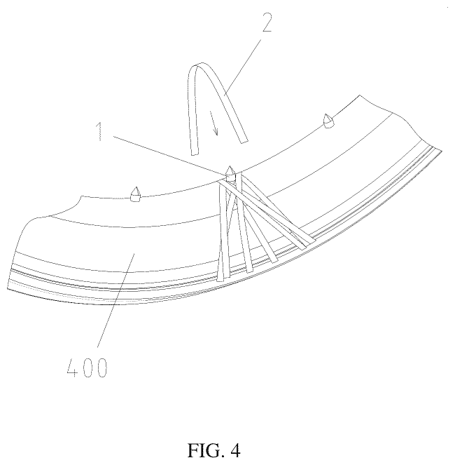

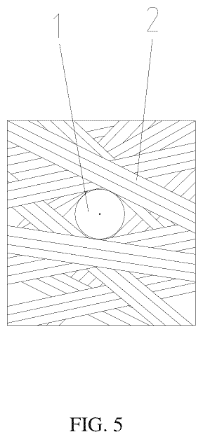

As shown in FIG. 4 and FIG. 5, a plurality of strip-shaped reinforcing units 2 are prepared, and the reinforcing units 2 are wound around the periphery of the convex column 1. The plurality of reinforcing units 2 are stacked on top of each other with most of the reinforcing units 2 staggered with each other, and finally, the reinforcing units 2 gradually form a basic outer contour of the spoke hole 103 around the periphery of the convex column 1. The winding of the reinforcing units 2 is the method by which the reinforcing units 2 extend around the convex column 1 by bypassing the convex column 1 and substantially cover the periphery of the convex column 1. The reinforcing unit 2 may be very close to the convex column 1 until it is substantially tangent to the convex column 1 or even abuts against the convex column 1 so as to form the shape contour of the spoke hole 103 more accurately. The reinforcing unit 2 may also be properly away from the convex column 1 so as to make up for the gap formed between the stacked and staggered reinforcing units 2.

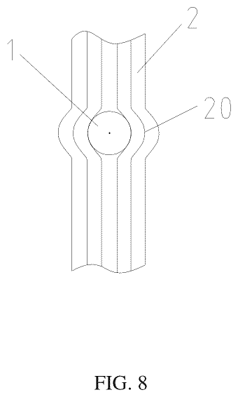

The winding of the reinforcing units 2 may be realized manually or by an automatic machine. When the winding is realized manually, the worker may consciously prevent the reinforcing units 2 from covering the top of the convex column 1. When the winding is realized by an automatic machine, numerical control programming and positioning may be used to prevent the reinforcing units 2 from covering the top of the convex column 1. In this example, as shown in FIG. 3, an end 11 of the convex column 1 facing inward in the radial direction of the preform mold 400 further has a sharp shape. In this way, even if the reinforcing unit 2 covers the top of the convex column 1 during winding, it will be pierced by the convex column 1 and finally pierced by squeezing by the convex column 1 as shown in FIG. 8. In this case, the reinforcing unit 2 fits the periphery of the convex column 1 more closely. Moreover, since the reinforcing unit 2 is pierced by squeezing, the reinforcing fibers therein can substantially remain continuous. This convex column 1 having a sharp end is apparently very suitable for winding the reinforcing units 2 with an automatic machine, because it is not necessary to try to avoid the winding direction directly faced by the convex column 1. However, since the reinforcing units 2 are continuously wound around the periphery of the convex column 1 to substantially cover the periphery of the convex column 1, there are few reinforcing units 2 that can be pierced by the convex column 1. The sharp end of the convex column 1 can also play a certain guiding role, so that the reinforcing units 2 can be wound more smoothly. In other examples, for example, in the case of manually winding the reinforcing units 2, the convex column 1 may also have a cylindrical structure with a uniform diameter.

The setting of the reinforcing unit 2 on the preform mold 400 may be realized by existing means, for example, hot air may be blown to the reinforcing unit 2 such that the reinforcing unit can substantially set on the preform mold 400. The reinforcing unit 2 may have a ribbon-shaped structure in the example shown in FIG. 4, so that it can be attached to the preform mold 400 more closely.

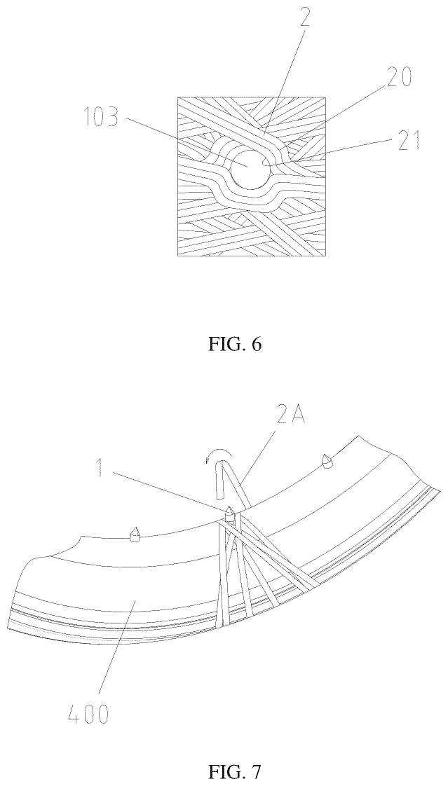

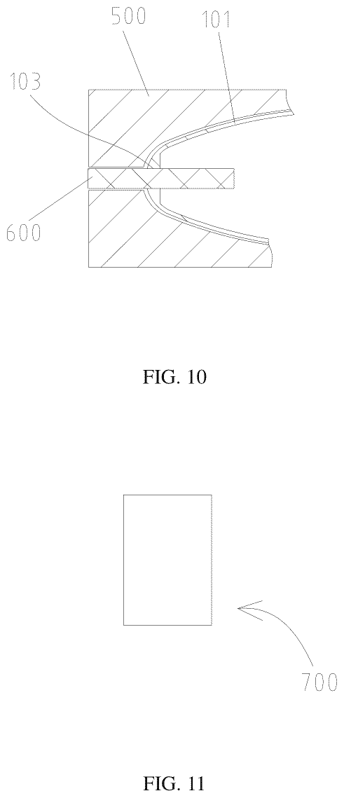

It can be expected that the reinforcing units 2 cannot completely fill the space around the periphery of the convex column 1 during winding. FIG. 5 shows a planar developed view of the reinforcing units 2 wound around the convex column 1. The reinforcing units 2 may leave some gaps around the periphery of the convex column 1, but during subsequent heating-curing, the reinforcing units 2 can fill these gaps because the reinforcing units 2 are thermoplastic. Specifically, after the reinforcing units 2 are preformed on the preform mold 400, the reinforcing units 2 are separated from the preform mold 400 to obtain the rim preform structure with the basic outer contour of the spoke holes 103, and finally, the rim preform structure is put into a thermoset mold for heat-curing. As shown in FIG. 10, in the thermoset mold 500, a pin 600 is inserted into each of the spoke holes formed by the enclosure of the reinforcing units 2. As long as the pin 600 can be positioned in the chamber of the thermoset mold 500, once the heat-curing is completed, the reinforcing units 2 can shape a complete structure of the spoke hole 103 around the pin 600. FIG. 6 shows a developed view of the reinforcing units 2 around the spoke hole 103 after the rim 100 is thermoset-molded. Part of the reinforcing units 2 will further bend to fit the pin more closely due to their thermoplasticity, thereby filling the gaps around the periphery of the pin. Each of the reinforcing units 2 includes at least one layer of reinforcing fibers 20, and the reinforcing fibers 20 of these bent reinforcing units 2 are distributed on a same side of the spoke hole 103 and bend away from the spoke hole 103 toward a common direction. In a case where the reinforcing unit 2 is pierced by squeezing as shown in FIG. 8, the reinforcing fibers 20 of the reinforcing unit 2 are distributed on two sides of the spoke hole 103 and bend away from the spoke hole 103 toward opposite directions. It can be expected that the pins 600 also extend toward the center of circle along the radial direction or extend substantially along the radial direction with a slight eccentricity depending on how the spokes are woven between the rim and the hub, so as to finally form the spoke holes 103.

In this example, since the basic shape of the spoke hole 103 is formed in the preforming stage before the rim 100 is heat-cured, the reinforcing fibers 20 in the reinforcing unit 2 are continuous in a length direction of strip extension of the reinforcing unit 2, so that the ability of the edge of the spoke hole 103 to bear an axial load is effectively enhanced. If the sharp end of the convex column 1 is not used to pierce the reinforcing units 2, the reinforcing fibers of the reinforcing units 2 that are wound around the periphery of the convex column 1 to form the spoke hole 103 will substantially not be broken at all (in an ideal state, they are not broken at all, but the unexpected situation of fiber breakage in the manufacturing of the reinforcing units 2 cannot be ruled out). In the case where the sharp end of the convex column 1 is used to pierce the reinforcing units 2, a small part of the reinforcing fibers of the reinforcing units 2 that are wound around the periphery of the convex column 1 to form the spoke hole 103 will be broken. However, on the one hand, the reinforcing units 2 are pierced by squeezing by the convex column 1, so there are only few broken reinforcing fibers 20. On the other hand, there is only a very small proportion of reinforcing units 2 that will contact the sharp end of the convex column 1, so the reinforcing fibers of these reinforcing units 2 are still substantially not broken on the whole.

In the example shown in FIG. 4, there are a plurality of broken reinforcing units 2. The individual reinforcing unit 2 bends in a U-shape in a manner of surrounding a circumferential direction of the rim (or the preform mold 400), and the reinforcing unit 2 half-surrounds the preform mold 400 in a manner of not passing through a radial outer end of the preform mold 400. The reinforcing unit 2 fits the inner end of the preform mold 400, so that a plurality of the reinforcing units 2 can form the basic shape of the U-shaped spoke connecting portion 101 extending from the radial inner end to the radial outer end of the rim 100. In this case, the reinforcing units 2 can be directly separated from the preform mold 400. FIG. 7 shows another feasible alternative example. In this alternative example, the reinforcing unit 2A is longer, and the reinforcing unit 2A continuously and completely surrounds the preform mold 400 in a manner of passing through the radial outer end of the preform mold 400 and is wound around the preform mold 400 multiple turns. In this case, the reinforcing unit 2A is wound more efficiently, but it is required to additionally remove, for example, by cutting, the part of the reinforcing unit 2A at the radial outer end of the preform mold 400 so as to make the reinforcing unit 2 separated from the preform mold 400 more easily.

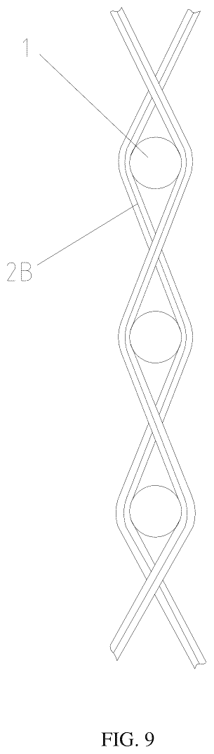

In both the example shown in FIG. 4 and the alternative example shown in FIG. 7, the reinforcing units are wound in the manner of surrounding the circumferential direction of the rim (or the preform mold 400). Additionally, as shown in FIG. 9, this example further provides an alternative example using a different winding direction. In this alternative example, the strip-shaped reinforcing unit 2B is wound in an S-shaped path from the periphery of the first convex column 1 to the periphery of the second convex column 1 adjacent thereto in a manner of surrounding an axial direction of the convex column 1, and after molding, the strip-shaped reinforcing unit 2B is wound in an S-shaped path from the periphery of the first spoke hole 103 to the periphery of the second spoke hole 103 adjacent thereto in a manner of surrounding an axial direction of the spoke hole 103. In this solution, the convex column 1 preferably has a cylindrical structure with a uniform diameter. Moreover, the reinforcing unit 2B may be curled into a rod shape before winding, or the reinforcing unit 2 may be continuously folded in a Z shape to form a multilayer structure, so that the reinforcing unit 2B can be wound around the periphery of the convex column 1 more stably. This alternative example allows for faster molding of the circumference at the inner end of the rim.

As shown in FIG. 3, in this example, the preform mold 400 is further provided with grooves 3 each around the periphery of the convex column 1, and before winding the reinforcing units 2, at least one sheet-like reinforcing substrate 700 (as shown in FIG. 11) may be laid in each of the grooves 3. The reinforcing substrate 700 is allowed to be pierced by the convex column 1 during the laying process. Alternatively, the reinforcing substrate 700 may be provided with a via hole for the convex column 1 to run through. The reinforcing substrate 700 arranged can improve the thickness at the spoke hole 103 and increase the strength of the spoke hole 103. After the rim 100 is thermoset-molded, the reinforcing substrate 700 is arranged on a side of the reinforcing unit 2 facing outward in the radial direction of the rim 100.

The strip-shaped reinforcing unit 2 may be obtained by cutting the existing preimpregnated composite reinforcing material, for example, whole carbon fiber cloth is cut to obtain the strip-shaped reinforcing unit 2.

Although the reinforcing unit 2 is made of carbon fiber cloth in the above example, in other examples, the reinforcing unit may be made of another high-strength fiber material that is either the same as or different from the material of the rim, such as glass fibers, aramid fibers, basalt fibers and ultra-high molecular weight polyethylene (UHMWPE) fibers.

This example mainly provides a method of forming the shape of the spoke connecting portion 101 in areas around the peripheries of the spoke holes 103 (convex columns 1). The interval areas between the convex column 1 and the convex column 1 in the circumferential direction may be covered by winding the reinforcing units 2 or attaching a large carbon fiber sheet. The top portion 102 may be formed by the existing method, and finally, the spoke connecting portion 101 and the top portion 102 are spliced and heat-cured to obtain the rim 100.

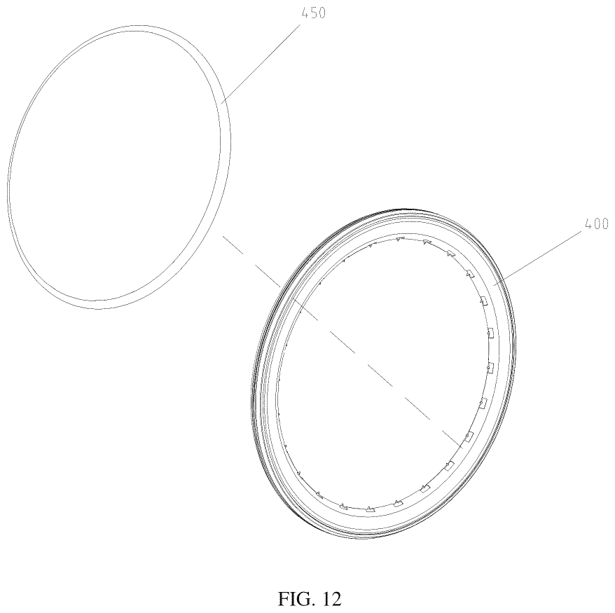

In order to improve the forming quality, as shown in FIG. 12, at least one layer of annular ribbon-shaped stiffener 450 may further be laid along a circumference at the inner end of the preform mold 400 before winding the reinforcing units 2. The stiffener 450 is allowed to be pierced by the convex columns 1 during the laying process, or the stiffener 450 may be provided with via holes for the convex columns 1 to run through. There may be a plurality of layers of stiffeners 450. The stiffener 450 is also woven carbon fibers impregnated with a thermosetting resin, and the weft direction and the warp direction of the fibers preferably form angles of +45° and −45° with the circumferential direction.

As can be seen, the orientation of the stiffener 450 is very close to the orientation of the reinforcing units 2B in the alternative example shown in FIG. 9, so the stiffener 450 may also be laid in the same way as the reinforcing units 2B, i.e., the stiffener 450 is laid in such a way that it is wound in an S-shaped path from the periphery of the first convex column 1 to the periphery of the second convex column 1 adjacent thereto in a manner of surrounding the axial direction of the convex column 1.

Depending on the required strength of the rim, either the stiffener 450 or the reinforcing substrates 700 may be laid, or both the stiffener 450 and the reinforcing substrates 700 may be laid.

This example further provides the structure of the above-mentioned rim 100. A plurality of the reinforcing units 2 are stacked on top of each other around the spoke hole 103 in a staggered manner, and at least part of the reinforcing units 2 adjoining the spoke hole 103 are combined to construct an outer contour of the spoke hole 103. The reinforcing units 2 adjoining the spoke hole 103 are the reinforcing units 2 that are closest to the spoke hole 103 and form the periphery of the spoke hole 103. Further, inner side edges 21 of the reinforcing units 2 adjoining the spoke hole 103 are stacked one by one and form the outer contour of the spoke hole 103. These reinforcing units 2 adjoining the spoke hole 103 are tangent or substantially tangent to the spoke hole 103 (some of the reinforcing units 2 overlap with the partial arc-shaped structure at the edge of the spoke hole 103). The reinforcing fibers 20 are continuous or substantially continuous in a strip length direction of the reinforcing unit 2, so that the ability of the edge of the spoke hole to bear an axial load is enhanced. For a more detailed description of the reinforcing units 2 and the reinforcing fibers 20, reference may be made to the above description.

Based on the structure of the above-mentioned rim 100, this example further provides a structure of the above-mentioned wheel 900. The wheel 900 is made of the rim 100, so the strength at the spoke holes 103 is improved, and the service life of the wheel is extended.

Although the disclosure has been specifically shown and described in connection with the preferred embodiments, it should be understood by those skilled in the art that various changes made thereto in forms and details without departing from the spirit and scope of the disclosure as defined in the appended claims shall fall within the scope of protection of the disclosure.

1. A rim, comprising a spoke connecting portion at a radial inner end, wherein the spoke connecting portion is provided with spoke holes, a periphery of each of the spoke holes has strip-shaped reinforcing units, each of the strip-shaped reinforcing units comprises at least one layer of reinforcing fibers, a plurality of the strip-shaped reinforcing units are stacked on top of each other around a corresponding one of the spoke holes in a staggered manner, and at least some of the strip-shaped reinforcing units are combined to construct an outer contour of the corresponding one of the spoke holes.

2. The rim according to claim 1, wherein the reinforcing fibers are continuous or substantially continuous in a strip length direction of a corresponding one of the strip-shaped reinforcing units.

3. The rim according to claim 1, wherein the at least some of the strip-shaped reinforcing units are tangent to the corresponding one of the spoke holes.

4. The rim according to claim 1, wherein in a strip length direction of a corresponding one of strip-shaped reinforcing units, the corresponding one of the strip-shaped reinforcing units bends and extends in an S-shaped path from the periphery of a first spoke hole of the spoke holes to the periphery of a second spoke hole of the spoke holes adjacent to the first spoke hole in a manner of surrounding an axial direction of the first spoke hole.

5. The rim according to claim 1, wherein in a strip length direction of the corresponding one of the strip-shaped reinforcing units, the corresponding one of the strip-shaped reinforcing units bends in a manner of surrounding a circumferential direction of the rim.

6. The rim according to claim 5, wherein each of the strip-shaped reinforcing units bends in a U-shape, and the plurality of the strip-shaped reinforcing units form the spoke connecting portion having a U-shape and extending from the radial inner end to a radial outer end of the rim.

7. The rim according to claim 1, wherein the reinforcing fibers of at least one of the strip-shaped reinforcing units are distributed on a same side of the corresponding one of the spoke holes and bend away from the corresponding one of the spoke holes toward a common direction, or the reinforcing fibers of at least one of the strip-shaped reinforcing units are distributed on two sides of the corresponding one of the spoke holes and bend away from the corresponding one of the spoke holes toward opposite directions.

8. The rim according to claim 1, wherein inner side edges of the strip-shaped reinforcing units adjoining the corresponding one of the spoke holes are stacked one by one and form the outer contour of the corresponding one of the spoke holes.

9. The rim according to claim 1, wherein at least one sheet-like reinforcing substrate is further laid on a side of one of the strip-shaped reinforcing units facing outward in a radial direction of the rim.

10. A wheel, comprising a rim, a hub and spokes connecting the rim and the hub, wherein the rim is the rim according to claim 1, the spokes each extend through one of the spoke holes, and the spokes are connected to a spoke connecting portion of the rim through a spoke connector.

11. A method of forming spoke holes in a rim, comprising:
arranging convex columns having a shape matched with that of the spoke holes,
winding strip-shaped reinforcing units around a periphery of each of the convex columns such that the strip-shaped reinforcing units gradually enclose a corresponding one of the convex columns and roughly construct an outer contour of a corresponding one of the spoke holes, and
separating the convex columns from the strip-shaped reinforcing units.

12. The method of forming spoke holes in a rim according to claim 11, wherein the convex columns are arranged on a preform mold, the preform mold has an annular or arc-shaped structure, the convex columns are fixedly arranged at a radial inner end of the preform mold at intervals in a circumferential direction of the preform mold, and the convex columns roughly extend inward in a radial direction of the preform mold.

13. The method of forming spoke holes in a rim according to claim 12, wherein an end of each of the convex columns facing inward in the radial direction of the preform mold has a pointed shape.

14. The method of forming spoke holes in a rim according to claim 12, wherein the preform mold is provided with grooves each around the periphery of the convex columns, and the method further comprises laying at least one sheet-like reinforcing substrate in each of the grooves before winding the strip-shaped reinforcing units.

15. The method of forming spoke holes in a rim according to claim 12, further comprising laying at least one layer of annular ribbon-shaped stiffener along a circumference at an inner end of the preform mold before winding the strip-shaped reinforcing units.

16. The method of forming spoke holes in a rim according to claim 12, wherein each of the strip-shaped reinforcing units bends in a manner of surrounding a circumferential direction of the preform mold, and
each of the strip-shaped reinforcing unit half-surrounds the preform mold in a manner of not passing through a radial outer end of the preform mold; or each of the strip-shaped reinforcing units completely surrounds the preform mold in a manner of passing through the radial outer end of the preform mold,
the method further comprises removing part of each of the strip-shaped reinforcing units at the radial outer end of the preform mold after the winding of the strip-shaped reinforcing units is completed.

17. The method of forming spoke holes in a rim according to claim 16, wherein each of the strip-shaped reinforcing units has a ribbon-shaped structure and is attached to a surface of the preform mold.

18. The method of forming spoke holes in a rim according to claim 12, wherein each of the strip-shaped reinforcing units is wound in an S-shaped path from the periphery of a first convex column of the convex columns to the periphery of a second convex column of the convex columns adjacent to the first convex column.

19. The method of forming spoke holes in a rim according to claim 11, wherein each of the strip-shaped reinforcing units is curled into a rod shape before winding.

20. The method of forming spoke holes in a rim according to claim 11, further comprising thermoset-molding the rim, wherein in a thermoset mold, a pin is inserted into each of the spoke holes formed by an enclosure of the strip-shaped reinforcing units.
